(19) United States
(12) Patent Application Publication
(10) Pub. No.: US 2014/0286559 A1
(43) Pub. Date: Sep. 25, 2014

(54) X-RAY CT APPARATUS, AND DISPLAY APPARATUS

(71) Applicants: Kabushiki Kaisha Toshiba, Minato-ku, Tokyo (JP); Toshiba Medical Systems Corporation, Otawara-shi, Tochigi (JP)

(72) Inventors: Go Mukumoto, Utsunomiya-shi (JP); Tatsuya Watanabe, Nasushiobara-shi (JP)

(73) Assignees: Kabushiki Kaisha Toshiba, Minato-ku, Tokyo (JP); Toshiba Medical Systems Corporation, Otawara-shi, Tochigi (JP)

(21) Appl. No.: 14/354,812

(22) PCT Filed: Aug. 23, 2013
(86) PCT No.: PCT/JP2013/072523

§ 371 Date: Apr. 28, 2014

(30) Foreign Application Priority Data
Aug. 31, 2012 (JP) 2012-190859
Aug. 22, 2013 (JP) 2013-172720

(51) Int. Cl. G06T 11/00

(52) U.S. Cl. CPC G06T 11/008
USPC 382/131

(57) ABSTRACT

X-ray CT apparatus and display apparatus are provided such that the executed operation plan can be instantaneously figured out and a desired operation plan can be easily selected from a plurality of the executed operation plans. X-ray CT apparatus of the embodiments performs X-ray scans based on an operation plan including a scan condition for X-ray scanning of a subject. The X-ray CT apparatus includes a creating unit, and a display controller. The creating unit creates a list of plan information indicating individual contents of a plurality of operation plans executed to one subject. The display controller causes a display to display the list created.

### TECHNICAL FIELD

The embodiments of the present invention are related to an X-ray CT apparatus and a display apparatus.

### BACKGROUND ART

X-ray CT (Computed Tomography) apparatuses are apparatuses which image the internal of a subject by scanning the subject with X-rays, and processing the acquired data by a computer.

Specifically, the X-ray CT apparatus radiates X-rays multiple times to the subject from different directions, detects the X-rays transmitted through the subject by an X-ray detector, and acquires a plurality of detection data. The acquired detection data is transmitted to a console apparatus after being A/D converted by a data acquisition system. The console apparatus implements pre-processing, or the like, on the detection data to create projection data. The console apparatus then implements reconstruction processing based on the projection data to create volume data based on one or a plurality of pieces of tomographic image data.

A series of operations (X-ray scanning, reconstruction process, and the like) by the X-ray CT apparatus is implemented based on an operation plan called an expert plan. The expert plan as an operation plan is information including a scan condition, a reconstruction process condition, and the like. The scan condition is a condition, required when the X-ray scanning is performed, such as a scanning mode (multislice, helical, or the like), a tube voltage, and a slice thickness. The reconstruction process condition is a condition, required when the reconstruction processing is performed, such as a reconstruction mode (multislice reconstruction technique, back projection technique, or the like), a reconstructed field of view, and a reconstruction function. Corresponding to parts of the subject (for example, for head, for coronary artery), or the like, individual expert plans are provided. There are cases such that the series of operations is performed multiple times in one-time inspection by executing a plurality of expert plans to one subject using the X-ray CT apparatus.

Further, the X-ray CT apparatus is able to cause a display to display a screen (hereinafter, may be referred to as “raw data page”), in which the detection data obtained by the X-ray scanning, or the like, is confirmed/processed. In the raw data page, displaying CT images based on the detection data (projection data), processing on the detection data (for example, re-execution of the reconstruction processing), and the like, are preformed.

### PRIOR ART DOCUMENT

### Patent Document

[Patent Document 1] Japanese Unexamined Patent Application Publication No. 2005-185549

### SUMMARY OF THE INVENTION

### Problems to be Solved by the Invention

Here, for example, when an operator is observing a CT image displayed on a raw data page, the operator sometimes wishes to know the expert plan executed for obtaining the CT image. Conventionally, in such the case, the operator has figured out the corresponding expert plan as referring to the displayed CT image, or the like. That is, it has been difficult for the operator to instantaneously figure out the executed expert plan.

Further, when a plurality of expert plans executed to one subject exist, there are cases that the operator wishes to select a desired expert plan in the raw data page and then confirm/process the detection data, and the like, obtained in accordance with the expert plan.

The embodiments are intended to solve the above-described problems, with the object of providing an X-ray CT apparatus and a display apparatus such that the executed operation plan can be instantaneously figured out and a desired operation plan can be easily selected from a plurality of the executed operation plans.

### Means of Solving the Problems

The X-ray CT apparatus of the embodiments performs X-ray scans based on an operation plan including a scan condition for X-ray scanning of a subject. The X-ray CT apparatus includes a creating unit, and a display controller. The creating unit creates a list of plan information indicating individual contents of a plurality of operation plans executed to one subject. The display controller causes a display to display the list created.

### BRIEF DESCRIPTION OF THE DRAWINGS

FIG. 1 is a block diagram of an X-ray CT apparatus according to a first embodiment.

FIG. 2 illustrates an example of a list according to the first embodiment.

FIG. 3A is a schematic diagram explaining a raw data page according to the first embodiment.

FIG. 3B is a schematic diagram explaining the raw data page according to the first embodiment.

FIG. 3C is a schematic diagram explaining the raw data page according to the first embodiment.

FIG. 4 is a flowchart illustrating an overview of operations of the X-ray CT apparatus according to the first embodiment.

FIG. 5 is a block diagram of the X-ray CT apparatus according to a second embodiment.

FIG. 6A is a schematic diagram explaining a raw data page according to the second embodiment.

FIG. 6B is a schematic diagram explaining the raw data page according to the second embodiment.

FIG. 6C is a schematic diagram explaining the raw data page according to the second embodiment.

FIG. 7 is a flowchart illustrating an overview of operations of the X-ray CT apparatus according to the second embodiment.

FIG. 8A is a schematic diagram explaining a raw data page according to a modified example 1.

FIG. 8B is a schematic diagram explaining the raw data page according to the modified example 1.

FIG. 9 is a schematic diagram explaining a raw data page according to a modified example 2.

FIG. 10 is a flowchart illustrating an overview of operations of the X-ray CT apparatus according to a modified example 3.

### MODES FOR CARRYING OUT THE INVENTION

### First Embodiment

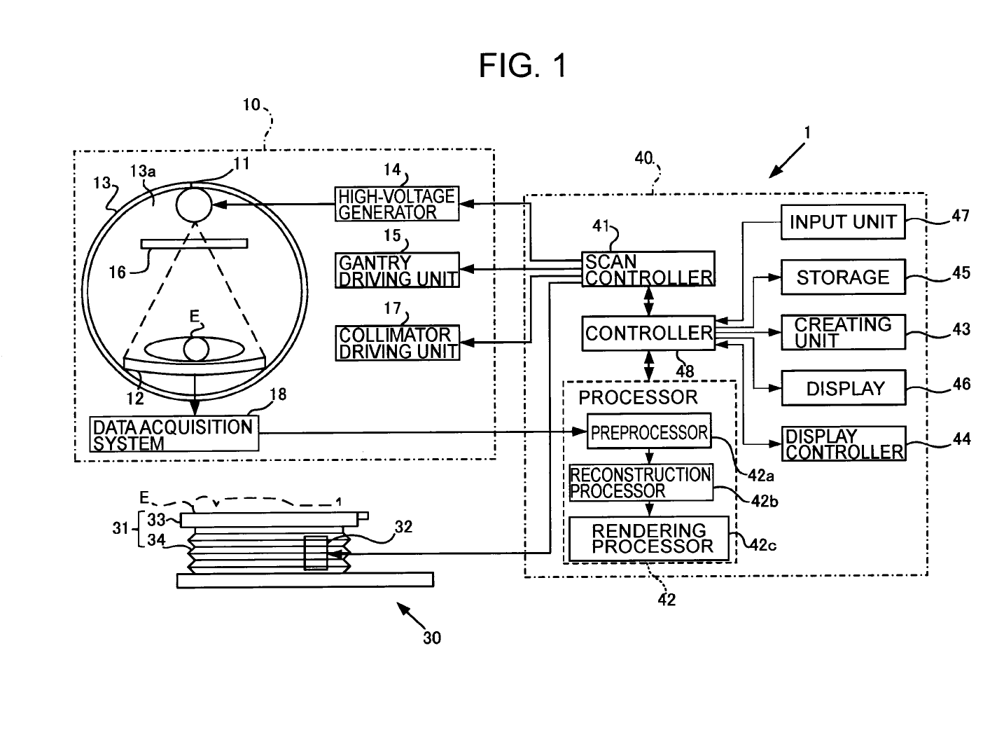

It is described a configuration of an X-ray CT apparatus 1 according to a first embodiment with reference to FIG. 1 to FIG. 4.

### <Apparatus Configuration>

As shown in FIG. 1, the X-ray CT apparatus 1 includes a gantry apparatus 10, a couch apparatus 30, and a console apparatus 40.

### [Gantry Apparatus]

The gantry apparatus 10 is an apparatus which radiates X-rays to a subject E, and acquires detection data of the X-ray transmitted through the subject E. The gantry apparatus 10 includes an X-ray generator 11, an X-ray detector 12, a rotating body 13, a high-voltage generator 14, a gantry driving unit 15, an X-ray collimator 16, a collimator driving unit 17, and a data acquisition system 18.

The X-ray generator 11 includes an X-ray tube (for example, a vacuum-tube which generates cone-shaped or pyramid-shaped beams. Not shown), which causes X-rays to be generated. The generated X-rays are radiated to the subject E. The X-ray detector 12 includes a plurality of X-ray detection elements (not shown). The X-ray detector 12 detects X-ray intensity distribution data (hereinafter, it may be referred to as “detection data”) indicating intensity distribution of the X-rays transmitted through the subject E with the X-ray detection elements, and outputs the detection data as a current signal. For the X-ray detector 12, a two-dimensional X-ray detector (area detector), in which a plurality of detection elements are respectively arranged in two directions (a slice direction and a channel direction) orthogonal to each other, is used, for example. The plurality of X-ray detection elements are arranged, for example, in 320 rows along the slice direction. Using such the multiple-row X-ray detector, it makes it possible to capture a three-dimensional capturing region having a width in the slice direction with a single rotation scan (volume scan). The slice direction corresponds to the axial direction of the subject E, and the channel direction corresponds to the rotational direction of the X-ray generator 11.

The rotating body 13 is a member which supports the X-ray generator 11 and the X-ray detector 12 facing each other so that the subject E is sandwiched therebetween. The rotating body 13 has an aperture 13a passing through in the slice direction. In the gantry apparatus 10, the rotating body 13 is arranged to rotate around the subject E in a circle orbit.

The high-voltage generator 14 applies a high-voltage to the X-ray generator 11. The X-ray generator 11 generates X-rays based on the high-voltage. The gantry driving unit 15 rotationally drives the rotating body 13. The X-ray collimator 16 has a slit (opening) with a predetermined width, and by changing the width of the slit, adjusts a fan angle (a spread angle in the channel direction) and a cone angle (a spread angle in the slice direction) of the X-rays radiated from the X-ray generator 11. The collimator driving unit 17 drives the X-ray collimator 16 so that the X-rays generated from the X-ray generator 11 to be in a predetermined form.

The DAS (Data Acquisition System) 18 acquires the detection data from the X-ray detector 12 (each X-ray detection element). The DAS 18 also converts the acquired detection data (current signal) to a voltage signal, periodically integrates and amplifies the voltage signal, and converts the amplified signal to a digital signal. The DAS 18 then transmits the detection data converted to the digital signal to the console apparatus 40 (a processor 42 (discussed later)).

### [Couch Apparatus]

The couch apparatus 30 is an apparatus to place and transfer the subject E of a capturing target. The couch apparatus 30 includes a couch 31, and a couch driving unit 32. The couch 31 includes a couch top 33 for placing the subject E, and a base 34 for supporting the couch top 33. The couch top 33 can be transferred in the rostrocaudal direction of the subject E and a direction orthogonal to the rostrocaudal direction, by the couch driving unit 32. That is, the couch driving unit 32 can insert and extract the couch top 33, on which the subject E is placed, into and from the aperture 13a of the rotating body 13. The base 34 can transfer the couch top 33 in a vertical direction (direction orthogonal to the rostrocaudal direction of the subject E) by the couch driving unit 32.

### [Console Apparatus]

The console apparatus 40 is used for operation input to the X-ray CT apparatus 1. The console apparatus 40 also has a function for reconstructing CT image data (tomographic image data, or volume data) representing internal morphology of the subject E from the detected data acquired by the gantry apparatus 10, and the like. The console apparatus 40 includes a scan controller 41, a processor 42, a creating unit 43, a display controller 44, a storage 45, a display 46, an input unit 47, and a controller 48.

The scan controller 41, the processor 42, the creating unit 43, the display controller 44, and the controller 48 are configured from, for example, not shown processing devices, such as CPU (Central Processing Unit), GPU (Graphic Processing Unit), and ASIC (Application Specific Integrated Circuit), and not shown storage devices, such as ROM (Read Only Memory), RAM (Random Access Memory), and HDD (Hard Disc Drive). In the storage devices, control programs for executing functions of each device are stored. The processing devices such as CPU execute the functions of each device by executing each program stored in the storage devices.

The scan controller 41 controls various kinds of operations related to the X-ray scanning. The scan controller 41 executes the X-ray scanning based on a scanning condition included in an expert plan set in advance. The expert plan is an operation plan (an capturing plan, a processing plan, or an execution plan) including the scanning condition, a reconstruction process condition, and the like. The scanning condition is a condition, required when the X-ray scanning is performed, such as a scanning mode (multislice, helical, or the like), a tube voltage, and a slice thickness. The reconstruction process condition is a condition, required when the reconstruction processing is performed, such as a reconstruction mode (multislice reconstruction technique, back projection technique, or the like), a reconstruction field of view, and a reconstruction function. Corresponding to parts of the subject (for example, for head, for coronary artery), or the like, individual expert plans are provided. For example, the scan controller 41 controls the high voltage generator 14 to apply a high voltage to the X-ray generator 11. The scan controller 41 controls the gantry driving unit 15 to rotational drive the rotating body 13. The scan controller 41 controls the collimator driving unit 17 to operate the collimator 16. The scan controller 41 also controls the couch driving unit 32 to transfer the couch 31.

The processor 42 executes various kinds of processing to the detection data transmitted from the gantry apparatus 10 (the DAS 18). The processor 42 includes a preprocessor 42a, a reconstruction processor 42b, and a rendering processor 42c.

The preprocessor 42a implements preprocessing, such as logarithmic transformation processing, offset correction, sensitivity correction, and beam hardening correction, on the detection data detected by the gantry apparatus 10 (the X-ray detector 12), and creates projection data.

The reconstruction processor 42b implements reconstruction processing on the projection data created by the preprocessor 42a, and creates CT image data (tomographic image data, or volume data). The reconstruction processor 42b executes the reconstruction processing based on a reconstruction process condition Rk (k=1 to n) (k, n are natural numbers. The same applies hereinafter) included in the expert plan set in advance.

For the reconstruction of the tomographic image data, any method among from, for example, two-dimensional Fourier transform method, convolution back projection method, and the like may be employed. The volume data is created by implementing interpolation processing on a plurality of tomographic image data, which have been reconstructed. For the reconstruction of the volume data, any method among from, for example, cone-beam reconstruction method, multi-slice reconstruction method, expansion reconstruction method, and the like may be employed. A wide range of volume data can be reconstructed by performing volume scanning using such the multiple-row X-ray detector as described above.

The rendering processor 42c implements rendering processing on the volume data created by the reconstruction processor 42b. For example, the rendering processor 42c renders the volume data created by the reconstruction processor 42b in any direction to perform MPR display. That is, the rendering processor 42c creates a MPR image.

Here, in the present embodiment, the X-ray CT apparatus 1 sequentially executes a plurality of expert plans EPₖ (k=1 to n) to one subject E. Specifically, the scan controller 41 performs X-ray scans based on the expert plan EPₖ. The preprocessor 42a implements the preprocessing on the detection data obtained for each expert plan EPₖ, and creates projection data. The reconstruction processor 42b implements the reconstruction processing on the projection data based on the reconstruction process condition Rk included in the expert plans EPₖ, and creates CT image data. The controller 48 causes the storage 45 to store the executed expert plans EPₖ and the obtained various kinds of data (the detection data, the projection data, and the CT image data) in association with each other. The X-ray CT apparatus 1 repeatedly performs the series of operations in accordance with the number of the set expert plans EPₖ. There is a case that a plurality of X-ray scannings are performed for one expert plan EPₖ. Further, it is possible to set a plurality of expert plans EPₖ to be executed to the subject E, prior to the X-ray scanning, by inputting desired plans via the input unit 47, or the like. Or it is also possible to set a plurality of expert plans EPₖ by selecting desired plans from a plurality of plans predetermined. The predetermined plans are stored in the storage 45, or the like.

The creating unit 43 creates a list L of plan information Pₖ (k=1 to n) indicating individual contents of a plurality of expert plans EPₖ executed to one subject E.

The plan information Pₖ is information (plan name) indicating the contents (a part of the contents) of the corresponding expert plan EPₖ. As the plan information Pₖ, the information (for example, the information related to the part of the subject E, the scanning mode, and the like) which makes the operator be able to figure out the corresponding expert plan EPₖ when he sees the information, may be included.

The creating unit 43 specifies the information (for example, the part of the subject E to be scanned, the scanning mode, and the like) to be indicated as plan information Pₖ among from the plurality of information included in the expert plan EPₖ, based on the instruction input from the input unit 47, or the like, and creates the plan information Pₖ by extracting and processing the specified information. The information indicated as the plan information Pₖ may be set in advance. It is also possible for the creating unit 43 to change the information to be indicated for each plan information Pₖ (described later).

The creating unit 43 also creates a list L of the plan information Pₖ corresponding to the plurality of expert plans EPₖ executed. The list L is a list in which a plurality of plan information Pₖ is shown. Here, the example of listing the plan information Pₖ created by the creating unit has been described. However, the creating unit 43 does not necessarily create the plan information Pₖ. For example, the storage 45 stores the previously set plan information Pₖ for each device. It is then possible for the creating unit 43 to create the list L based on the stored plan information Pₖ.

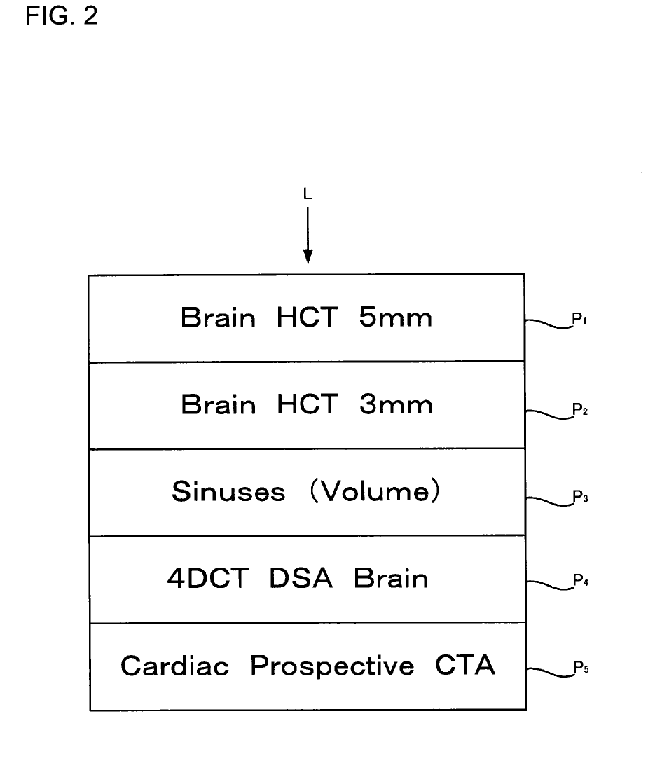

FIG. 2 is an example of the list L. For example, in the event of that five expert plans EP₁ to EP₅ were executed, the creating unit 43 creates plan information P₁ to P₅ corresponding to each expert plan. The creating unit 43 then creates the list L indicating the plan information P₁ to P₅.

For example, “Brain HTC 5 mm” is indicated in the plan information P₁. The operator can, therefore, instantaneously figure out a corresponding expert plan EP₁ (a plan to execute helical scanning for the brain with a slice thickness of 5 mm) from the plan information P₁. Further, since the plurality of plan information P₁ to P₅ are displayed in the list L, it is possible for the operator to easily select desired plan information (the expert plan corresponding to the plan information).

In the list L shown in FIG. 2, as described above, the creating unit 43 changes the information to show for each plan information Pₖ. That is, the contents (the part of the subject E to be scanned, the scanning mode, the slice thickness) that the plan information P₁ and the plan information P₂ indicate are different from the contents that plan information other than above indicate. For example, the plan information P₅ only indicates the part (heart) of the subject E to be scanned and the scanning mode (CTA: Computed Tomography Angiography).

The display controller 44 performs various kinds of controls related to the image display. For example, the display controller 44 controls to cause the display 46 to display a CT image based on the CT image data created by the reconstruction processor 42b. The display controller 44 can also arrange the display 46 to have one screen as one page, in which a plurality of display fields are provided, and cause different information and images to be displayed in each display field. A raw data page RP described hereinafter is one of the examples.

In the present embodiment, the display controller 44 causes the display 46 to display the list L created by the creating unit 43. Specifically, the display controller 44 causes the list L to be displayed at a predetermined area in the raw data page RP on the display 46.

Further, when first plan information desired is selected from the list L, the display controller 44 causes the display 46 to display a first CT image based on the X-ray scanning in accordance with a first expert plan (a first operation plan) corresponding to the first plan information as well as a first reconstruction process condition included in the first expert plan used when the first CT image is created.

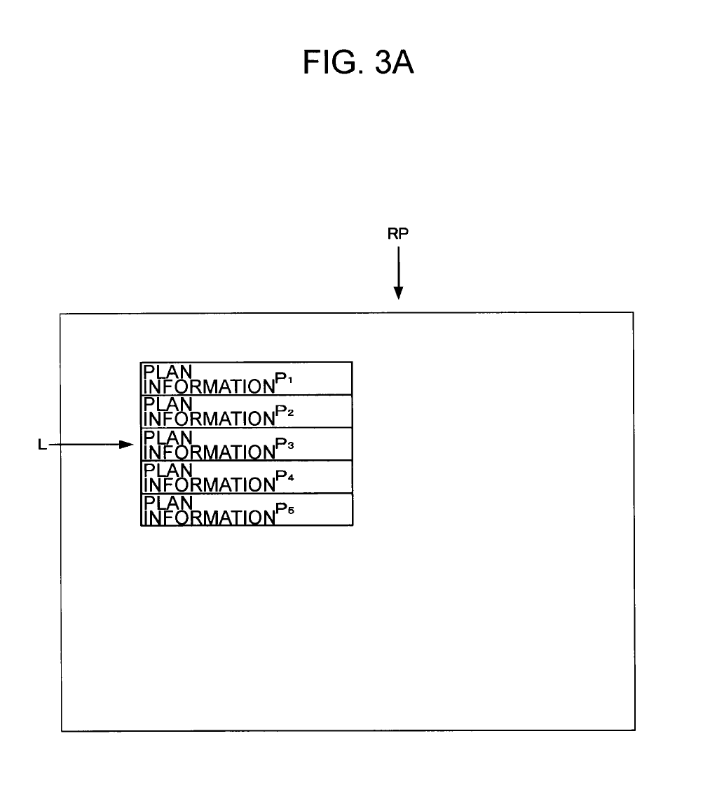

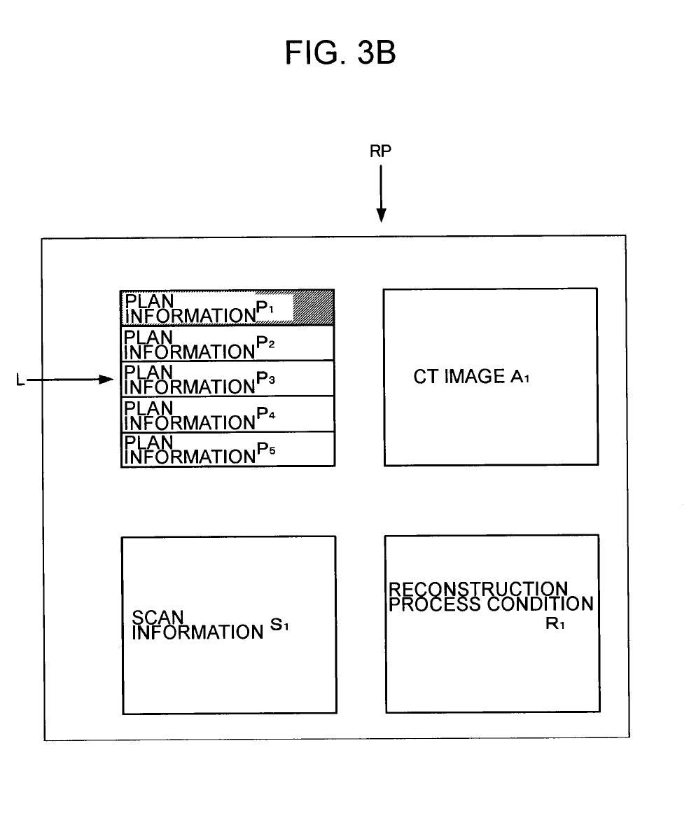

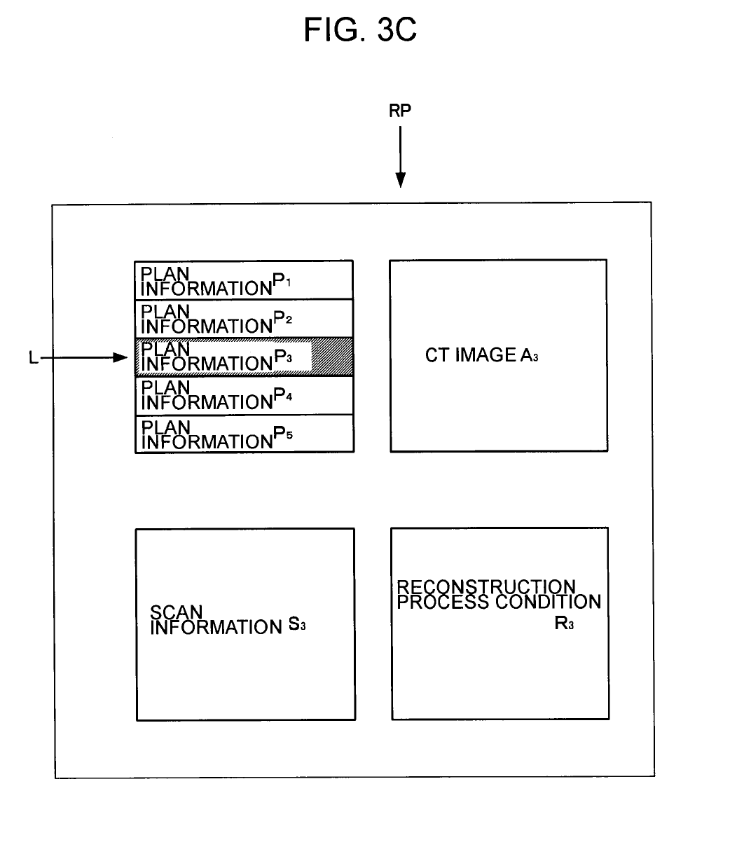

FIG. 3A to FIG. 3C are schematic diagrams illustrating the raw data page RP displayed on the display 46. In the FIG. 3A to FIG. 3C, only a part (the list L, scan information Sₖ (k=1 to n), a CT image Aₖ (k=1 to n), and the reconstruction process condition Rk) of the information and images displayed in the raw data page RP is illustrated.

The scan information Sₖ shows a result of the scanning actually executed based on the expert plan EPₖ corresponding to the plan information Pₖ. The starting position/ending position of the scanning actually executed, the number thereof, and the like are displayed, for example, as the scan information Sₖ. The CT image Aₖ is an image based on the reconstruction process condition Rk included in the expert plan EPₖ corresponding to the selected plan information Pₖ. The display of the list L, the scan information Sₖ, the CT image Aₖ, and the reconstruction process condition Rk is not limited to the arrangement in FIG. 3A to FIG. 3C.

The display controller 44 causes the display 46 to display the raw data page RP, based on the instruction input of the input unit 47, or the like.

When a patient ID, date, or the like are input in a predetermined field (not shown) in the row data page RP, the display controller 44 causes the list L indicating the plan information Pₖ corresponding to the patient ID, or the like, to be displayed in the raw data page RP (see FIG. 3A). The list L shown in FIG. 3A shows the plan information P₁ to P₅ indicating individual contents of the expert plans EP₁ to EP₅ executed to one subject E in an inspection.

When the operator selects desired plan information P₁ via the input unit 47, or the like, the display controller 44 causes scan information S₁, a CT image A₁, and reconstruction process condition R₁, corresponding to an expert plan EP₁ stored in the storage 45, or the like, to be displayed (see FIG. 3B).

Further, when plan information P₃, which is different from the plan information P_{I}, is selected, the display controller 44 causes scan information S₃, a CT image A₃, and a reconstruction process condition R₃, corresponding to an expert plan EP₃, to be displayed (see FIG. 3C).

The above-mentioned plan information P₁ is an example of the “first plan information”. The expert plan EP₁ is an example of the “first operation plan”. The CT image A₁ is an example of the “first CT image”. The reconstruction process condition R₁ is an example of the “first reconstruction process condition”. The plan information P₃ is an example of “second plan information”. The expert plan EP₃ is an example of a “second operation plan”. The CT image A₃ is an example of a “second CT image”.

The storage 45 is configured with a semiconductor storage device, such as a RAM and a ROM. The storage 45 stores detection data, projection data, CT image data after the reconstruction processing is performed, and the like, in association with the expert plans.

The display 46 is configured with any display device, such as a LCD (Liquid Crystal Display), and a CRT (Cathode Ray Tube) display. The display 46 displays, for example, a raw data page.

The input unit 47 is used as an input device for performing various kinds of operations for the console apparatus 40. The input unit 47 is, for example, a keyboard, a mouse, a trackball, a joystick, or the like. It is also possible to use a GUI (Graphical User Interface) displayed on the display 46 as the input unit 47.

The controller 48 controls the whole of the X-ray apparatus 1 by controlling the operations of the gantry apparatus 10, the couch apparatus 30, and the console apparatus 40. For example, the controller 48 implements the preliminary scanning and the main scanning for the gantry apparatus 10 by controlling the scan controller 41, in order to acquire detection data. The controller 48 also implements various kinds of processing (preprocessing, reconstruction processing, MPR processing, and the like) on the detection data by controlling the processor 42. Or by controlling the display controller 44, the controller 48 causes the display 46 to display a CT image, based on the image data, or the like, stored in the storage 45.

### <Operations>

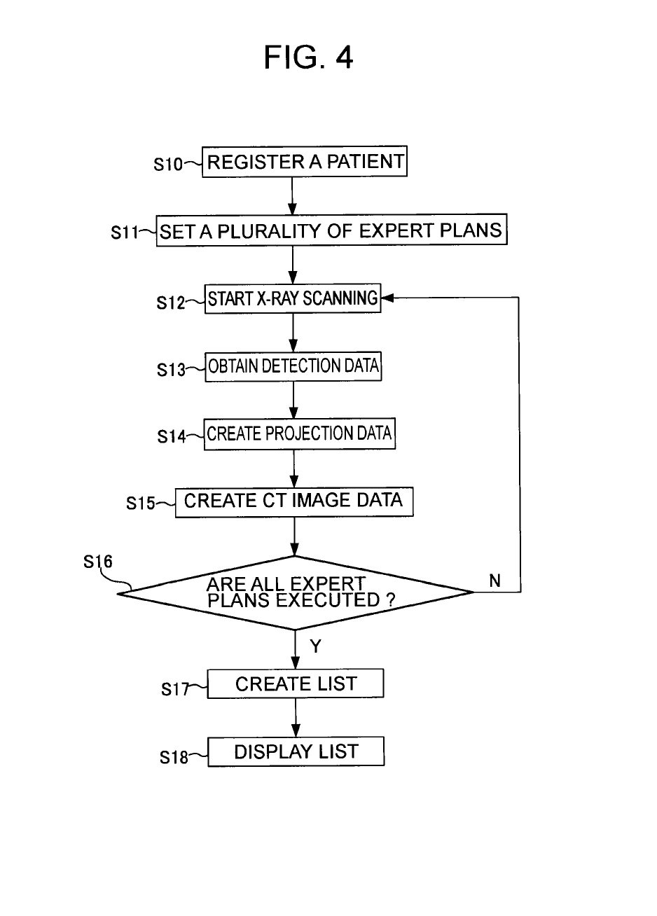

Next, with reference to FIG. 4, operations of the X-ray CT apparatus 1 according to the present embodiment are described. Here, it is described an example in which five expert plans EP₁ to EP₅ are executed to one subject E. Numbers S shown below are step numbers in FIG. 4.

The X-ray CT apparatus 1 registers the subject E (registers a patient), based on the instruction input via the input unit 47, or the like (S 10). The X-ray CT apparatus 1 also sets a plurality of expert plans to be executed to the subject E (here, the expert plans EP₁ to EP₅), based on the instruction input via the input unit 47, or the like (S11).

The X-ray CT apparatus 1 then starts X-ray scanning based on the expert plans EP₁ to EP_{S} set in S11 (S12).

Specifically, the X-ray generator 11 firstly radiates X-rays to the subject E, based on the expert plan EP₁. The X-ray detector 12 detects the X-rays transmitted through the subject E, and obtains the detection data (S13). The detection data detected by the X-ray detector 12 is acquired by the DAS 18, and transmitted to the processor 42 (the preprocessor 42a).

The preprocessor 42a implements the preprocessing, such as logarithmic transformation processing, offset correction, sensitivity correction, and beam hardening correction, on the detection data obtained in S13, and creates projection data (S14). The created projection data is transmitted to the reconstruction processor 42b, based on the control of the controller 48.

The reconstruction processor 42b applies the reconstruction process condition R₁ included in the expert plan EP₁, and creates CT image data, based on the projection data created in S14 (S15).

The X-ray CT apparatus 1 then sequentially performs the similar processes as in S12 to S15, based on the expert plans EP_{Z} to EP₅ (in the case that N in S16).

After all of the expert plans are executed (in the case that Y in S16), the creating unit 43 creates a list L of plan information P₁ to P₅ indicating individual contents of the five expert plans EP₁ to EP₅ (S17). The process in S17 may be executed in parallel with the operations in S12 to S15.

After S17, when the detection data, and the like, obtained by executing each expert plan are confirmed, the operator inputs the patient ID of the subject E, or the like, to the X-ray CT apparatus 1 via the input unit 47, or the like. Based on the patient ID, or the like, the display controller 44 causes the list L created in S17 to be displayed in the raw data page RP displayed on the display 46 (S 18).

The plan information P₁ to P₅ indicated in the list L indicates the contents of the corresponding expert plans EP₁ to EP₅. The operator, therefore, can instantaneously figure out the expert plans EP₁ to EP₅ executed to the subject E from the plan information P₁ to P₅ displayed in the list L. Further, in a case that, for example, the plan information P₁ is selected as desired plan information, a CT image A₁ as well as a reconstruction process condition R₁, obtained in accordance with the corresponding expert plan EP₁, can be confirmed on the display 46 (in the raw data page RP).

In the present embodiment, the configuration of the X-ray CT apparatus 1 has been described, however, the configuration which fulfills the works in the embodiment is not limited to the X-ray CT apparatus 1. For example, the similar functions as the embodiment can be realized by transmitting the expert plans EPₖ executed and the detection data obtained by the X-ray CT apparatus 1, and the like, to an apparatus (for example, a display apparatus, such as an image viewer) different from the X-ray CT apparatus 1, and implementing the similar processing within the apparatus. In such the case, it is desirable that the creating unit 43, the display controller 44, and the display 46 are arranged in the display apparatus.

### <Operations and Effects>

Operations and effects of the present embodiment are described.

The X-ray CT apparatus 1 of the present embodiment performs X-ray scans, based on an expert plan EPₖ including a scanning condition for X-ray scanning a subject E. The X-ray CT apparatus 1 includes the creating unit 43, and the display controller 44. The creating unit 43 creates a list L of plan information Pₖ (for example, plan information P₁ to P₅) indicating individual contents of a plurality of expert plans EPₖ (for example, expert plans EP₁ to EP₅) executed to one subject E. The display controller 44 causes the display 46 to display the created list L.

In this way, by displaying the plan information Pₖ indicating the contents of the expert plan EPₖ, the operator can easily know the contents of the expert plan EPₖ corresponding to the plan information Pₖ. The operator, therefore, can instantaneously figure out which expert plan has been executed. Further, by displaying the plurality of plan information in the list L, the expert plan EPₖ corresponding to desired plan information Pₖ can be easily selected. That is, according to the X-ray CT apparatus 1 of the present embodiment, it is possible to instantaneously figure out the executed expert plan, and easily select a desired expert plan from the plurality of expert plans executed.

The X-ray CT apparatus 1 of the present embodiment also includes the reconstruction processor 42b. The reconstruction processor 42b implements reconstruction processing on the projection data corresponding to the detection data obtained by the X-ray scanning, based on the reconstruction process condition Rk included in the expert plan EPₖ, and creates CT image data. When desired first plan information (for example, plan information P₁) is selected from the list L, the display controller 44 causes the display 46 to display a first CT image (for example, a CT image A₁), based on the X-ray scanning in accordance with a first expert plan (a first operation plan, for example, an expert plan EP₁) corresponding to the first plan information. When the desired first plan information (for example, the plan information P₁) is selected from the list L, the display controller 44 also causes the display 46 to display a first reconstruction process condition (for example, a reconstruction process condition R₁) included in the first expert plan used when the first CT image is created.

In this way, when desired plan information Pₖ is selected, a CT image Aₖ and a reconstruction process condition Rk corresponding to the plan information Pₖ are displayed on the display 46. The CT image Aₖ obtained in accordance with the expert plan EPₖ corresponding to the selected plan information Pₖ, the reconstruction process condition Rk used, and the like, can therefore be easily confirmed.

It is also possible for the configuration of the present embodiment to be applied to the display apparatus. Such the display apparatus includes the creating unit 43, the display 46, and the display controller 44. The creating unit 43 creates a list L of the plan information Pₖ indicating the individual contents of a plurality of expert plans EPₖ, including a scan condition for X-ray scanning the subject E, executed to one subject E. The display controller 44 causes the display 46 to display the created list L.

In this way, the operator can easily know the contents of the expert plan EPₖ corresponding to the plan information Pₖ by displaying the plan information Pₖ indicating the contents of the expert plan EPₖ, even in an external apparatus of the X-ray CT apparatus 1. Therefore, the operator can instantaneously figure out which expert plan has been executed. Further, by displaying the plurality of the plan information in the list L, the expert plan EPₖ corresponding to the plan information Pₖ desired can be easily selected. That is, according to the display apparatus of the present embodiment, it is possible to instantaneously figure out the executed expert plan, and easily select a desired expert plan from the plurality of the executed expert plans.

### Second Embodiment

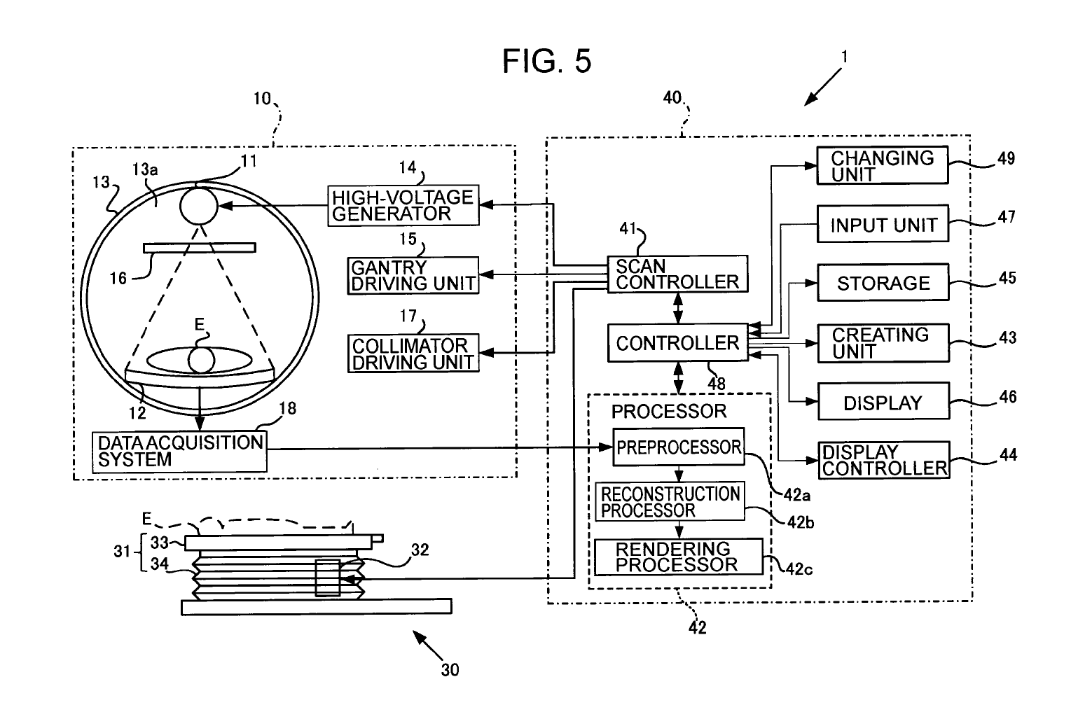

Next, a configuration of the X-ray CT apparatus 1 according to a second embodiment is described with reference to FIG. 5 to FIG. 7. In the present embodiment, in a case such that a reconstruction process condition included in an expert plan is changed, a configuration, in which the changed reconstruction process condition is applied also to other expert plans, is described. The change of the reconstruction process condition included in the expert plan includes addition of new reconstruction process condition to the expert plan. Detail explanations for the configuration similar to that of the first embodiment, and the like, may be omitted.

### <Apparatus Configuration>

As shown in FIG. 5, the X-ray CT apparatus 1 of the present embodiment includes, similar to the one in the first embodiment, the gantry apparatus 10, the couch apparatus 30, and the console apparatus 40.

The console apparatus 40 of the present embodiment includes a changing unit 49. The changing unit 49 changes a reconstruction process condition Rk displayed on the display 46, based on the instruction input via the input unit 47. Hereinafter, the changed reconstruction process condition Rk is indicated by a reconstruction process condition Rk′ (k=1 to n).

In this way, by freely changing the reconstruction process condition Rk, it is possible for the reconstruction processor 42b to create various kinds of CT image data, based on one detection data (projection data). The controller 48 can cause the storage 45 to store the reconstruction process condition Rk′ and the CT image data reconstructed based on the reconstruction process condition Rk′, in association with an expert plan EPₖ.

Further, in the present embodiment, in a case such that second plan information, which is different from the first plan information, is selected from a list L, the display controller 44 causes the display 46 to display a second CT image based on the X-ray scanning in accordance with a second expert plan (a second operation plan) corresponding to the second plan information, as well as a changed first reconstruction process condition.

Furthermore, in the present embodiment, in a case such that the second plan information is selected from the list L, the reconstruction processor 42b creates new CT image data by implementing reconstruction processing again on the projection data configuring the second CT image, based on the changed reconstruction process condition. The display controller 44 causes the display 46 to display a third CT image based on the new CT image data.

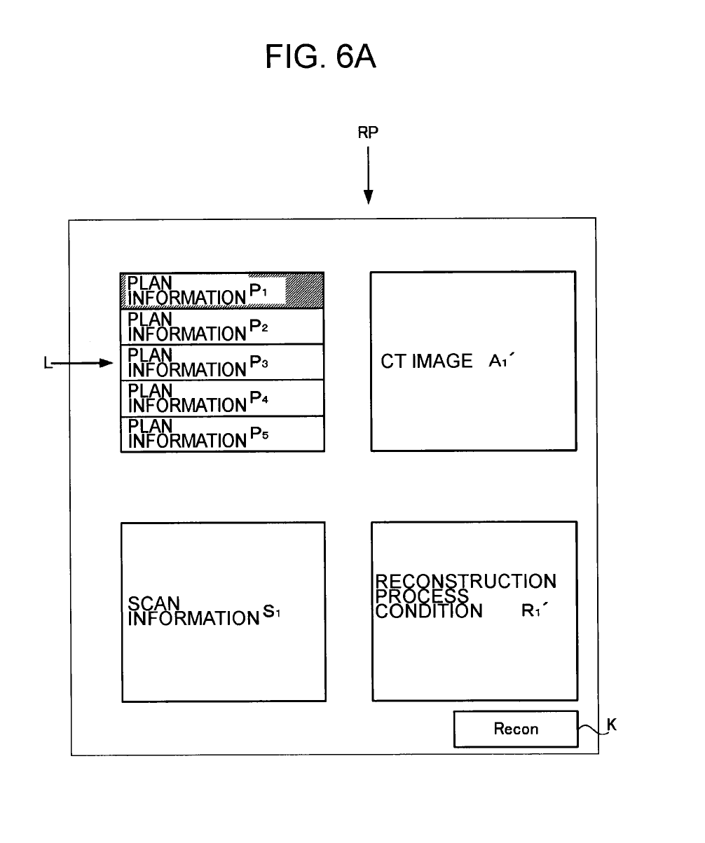

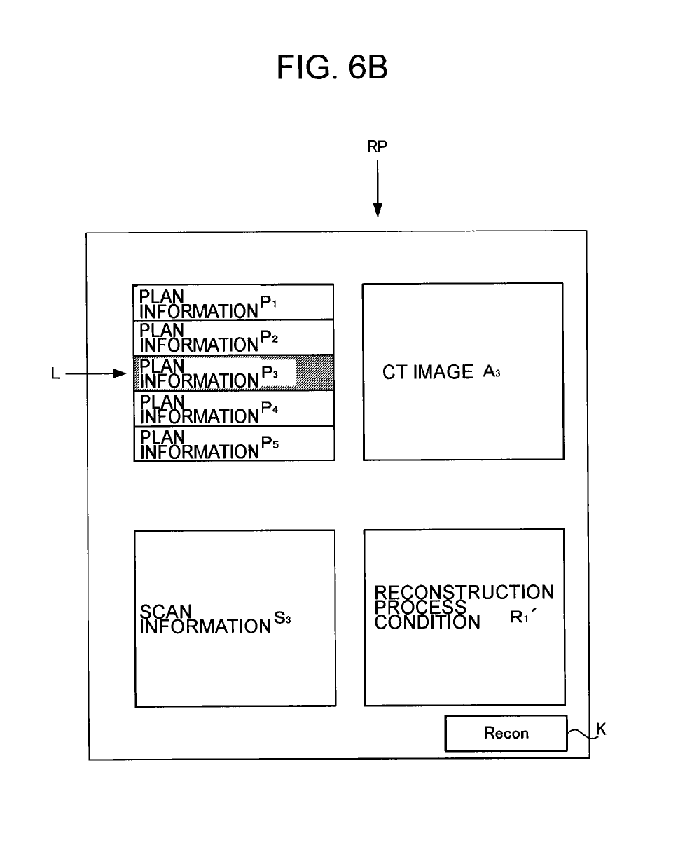

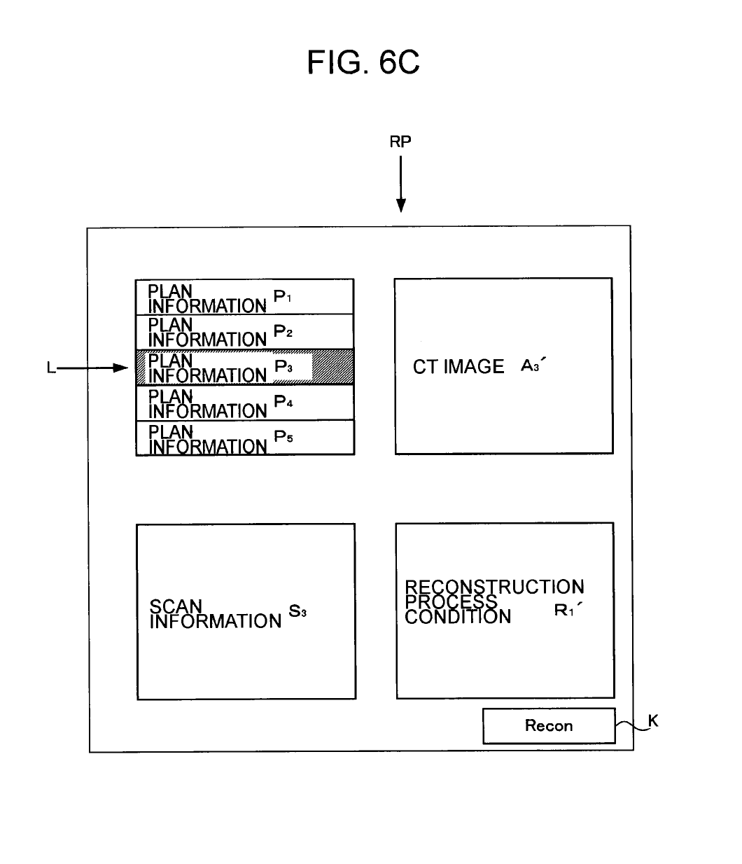

FIG. 6A to FIG. 6C are schematic diagrams illustrating a raw data page RP displayed on the display 46. In FIG. 6A to FIG. 6C, only a part of the information and images displayed in the raw data page RP is illustrated. “Recon” is a softkey K for instructing the execution of the reconstruction process. When the softkey K is selected via the input unit 47, or the like, the reconstruction processor 42b implements the reconstruction processing (re-executes the reconstruction processing) based on the reconstruction process condition displayed on the display 46. A CT image Aₖ′ (k=1 to n) is an image based on the reconstruction process condition Rk′.

In a case such that the operator selects desired plan information P₁ via the input unit 47, or the like, the display controller 44 causes scan information S₁, a CT image A₁, and a reconstruction process condition R₁, all corresponding to an expert plan EP_{I}, to be displayed (see FIG. 3B in the first embodiment).

In this state, when the value of the reconstruction process condition R₁ is changed via the input unit 47, the changing unit 49 generates a reconstruction process condition R₁′, based on the changed value (see FIG. 6A). When the softkey K is selected after generating the reconstruction process condition R₁′, the reconstruction processor 42b implements the reconstruction processing on the projection data configuring the CT image A₁ in accordance with the reconstruction process condition R₁′ to create CT image data. The display controller 44 causes the display 46 to a display CT image A₁′ based on the CT image data (see FIG. 6A).

Here, in the present embodiment, when plan information P₃, which is different from the plan information P₁, is selected, the display controller 44 causes the reconstruction process condition R₁′ to be displayed in the raw data page along with scan information S₃ and a CT image A₃, corresponding to expert plan EP₃ (see FIG. 6B). That is, the display controller 44 causes the reconstruction process condition R₁′ set for the earlier selected plan information P₁ to be succeeded as the reconstruction process condition for the plan information P₃ and displayed. In this case, the display controller 44 does not cause the reconstruction process condition R₃ corresponding to the expert plan EP₃ to be displayed. Or, in this case, the display controller 44 may cause the reconstruction process condition R₁′ and the reconstruction process condition R₃ to be displayed in parallel.

Whether to succeed the reconstruction process condition R₁′ can be set in advance by the operator via the input unit 47, for example. When the condition is set to be succeeded, the display controller 44 causes the display 46 to display the reconstruction process condition R₁′. When the condition is set not to be succeeded, the display controller 44 causes the display 46 to display the reconstruction process condition R₃ included in the expert plan EP₃. In such a case that the reconstruction process condition Rk is changed and the different plan information is selected, it may be possible for the display controller 44 to automatically succeed the reconstruction process condition Rk′.

When the softkey K is selected in the state of FIG. 6B, the reconstruction processor 42b again implements the reconstruction processing on the projection data configuring the CT image A₃ in accordance with the reconstruction process condition R₁′ to create new CT image data. The display controller 44 causes the display 46 to display, instead of the CT image A₃, a CT image A₃′ based on the new CT image data (see FIG. 6C). When the reconstruction process condition Rk is changed and different plan information is selected, it may also be possible for the reconstruction processor 42b to automatically implement the reconstruction processing, based on the selection of the different plan information, and create new CT image data.

The above-mentioned plan information P₁ is an example of the “first plan information”. The expert plan EP₁ is an example of the “first operation plan”. The CT image A₁ is an example of the “first CT image”. The reconstruction process condition R₁ is an example of the “first reconstruction process condition”. The plan information P₃ is an example of the “second plan information”. The expert plan EP₃ is an example of the “second operation plan”. The CT image A₃ is an example of the “second CT image”. The reconstruction process condition R₁′ is an example of the “changed first reconstruction process condition”. The CT image A₃′ is an example of the “third CT image”.

### <Operations>

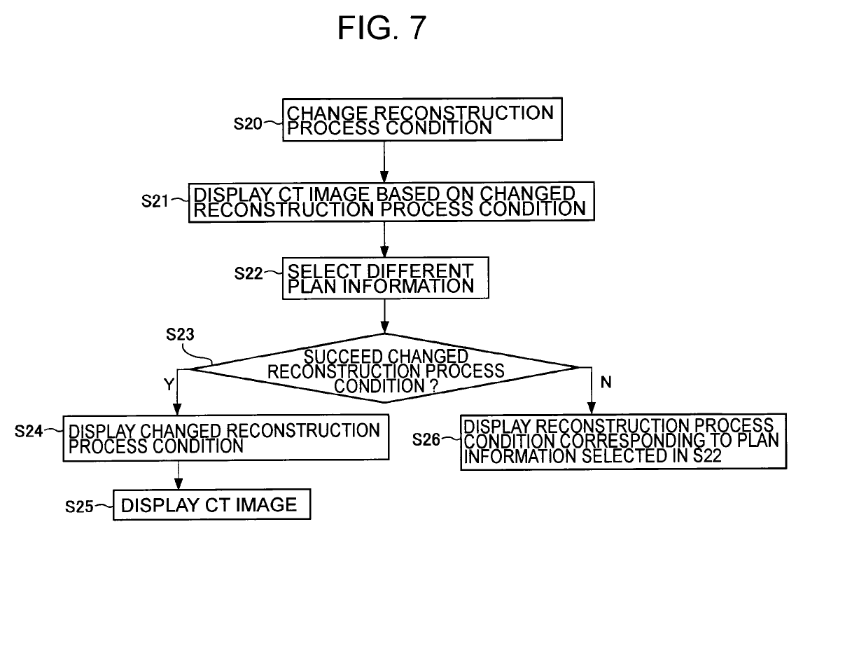

Next, with reference to FIG. 7, operations of the X-ray CT apparatus 1 according to the present embodiment are described. Here, it is described assuming that it is a state such that the plan information P₁ is selected from the list L and the scan information S₁, the CT image A₁, as well as the reconstruction process condition R₁ are displayed in the raw data page RP (the state in FIG. 3B of the first embodiment). Numbers S shown below are step numbers in FIG. 7.

For example, when a CT image easier to observe than the CT image A₁ currently displayed is required to obtain, the operator changes the value of the reconstruction process condition R₁ via the input unit 47. The changing unit 49 changes the reconstruction process condition R₁ based on the instruction input from the input unit 47 to generate a reconstruction process condition R₁′ (S20).

When the softkey K is selected in the state of S20, the reconstruction processor 42b again implements the reconstruction processing on the projection data configuring the CT image A₁ based on the reconstruction process condition R₁′ to create CT image data. The display controller 44 causes the display 46 to display a CT image A₁′ based on the CT image data (S21. see FIG. 6A).

It is then assumed that plan information P₃, which is different form the plan information P₁, is selected in the raw data page RP by the operator (S22). At this point, the display controller 44 causes a CT image A₃ to be displayed in the raw data page RP.

Here, in a case that the reconstruction process condition R₁′ generated in S20 is succeeded (in the case that Y in S23), the display controller 44 causes the display 46 to display the reconstruction process condition R₁′ (S24. see FIG. 6B).

Further, when the softkey K is selected, the reconstruction processor 42b again implements the reconstruction processing on the projection data configuring the CT image A₃ in accordance with the reconstruction process condition R₁′ to create new CT image data. The display controller 44 causes the display 46 to display, instead of the CT image A₃, a CT image A₃′ based on the new CT image data (S25. see FIG. 6C).

On the other hand, in a case that the reconstruction process condition R₁′ generated in S20 is not succeeded (in the case that N in S23), the display controller 44 causes the display 46 to display a reconstruction process condition R₃ included in an expert plan EP₃ corresponding to plan information P₃ (S26).

### <Operations and Effects>

Operations and effects of the present embodiment are described.

The X-ray CT apparatus 1 of the present embodiment includes the changing unit 49. The changing unit 49 changes a first reconstruction process condition (for example, a reconstruction process condition R₁) displayed on the display 46. When second plan information (for example, plan information P₃), which is different from first plan information (for example, plan information P₁), is selected from a list L, the display controller 44 causes the display 46 to display a second CT image (for example, a CT image A₃) based on the X-ray scanning in accordance with a second expert plan (a second operation plan, for example, an expert plan EP₃) corresponding to the second plan information, as well as the changed first reconstruction process condition (for example, a reconstruction process condition R₁′).

Further, in the X-ray CT apparatus 1 of the present embodiment, when the second plan information (for example, the plan information P₃) is selected, the reconstruction processor 42b creates new CT image data by again implementing the reconstruction processing on the projection data configuring the second CT image (for example, the CT image A₃) based on the changed first reconstruction process condition (for example, the reconstruction process condition R1′). The display controller 44 causes the display 46 to display a third CT image (for example, a CT image A₃′) based on the new CT image data.

In this way, when different plan information is selected, the reconstruction process can be executed on different detection data obtained in accordance with a plurality of the expert plans EPₖ under the similar conditions by succeeding the reconstruction process condition changed in the previous plan information. A desired reconstruction process condition can therefore be applied without setting a reconstruction process condition every time selecting the plan information. That is, according to the X-ray CT apparatus 1 of the present embodiment, in addition to the effects of the first embodiment, the reconstruction process condition setting over the plurality of the expert plans becomes easier.

### Modified Example 1

In the second embodiment, the example in which the changed reconstruction process condition is succeeded was described, however, the succession of the reconstruction process condition is not limited to this. That is, there may be a case that, without changing a reconstruction process condition for one plan information, the condition is desirably applied to other plan information.

For example, in the state in FIG. 3B of the first embodiment, it is described a case that, without changing the reconstruction process condition R₁, the condition is desirably applied to the reconstruction process based on the expert plan EP₃ corresponding to the plan information P₃.

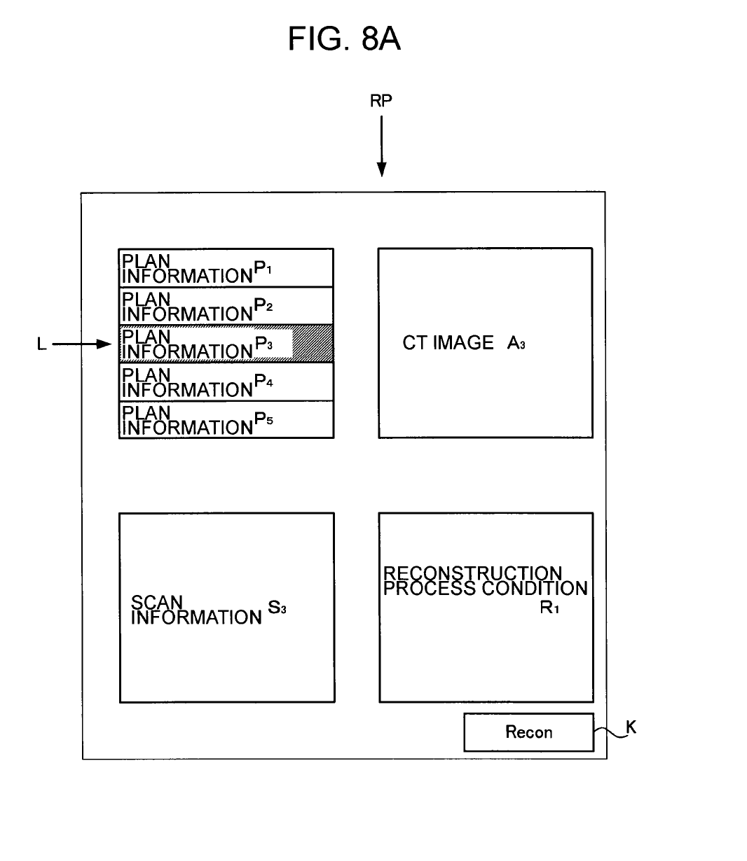

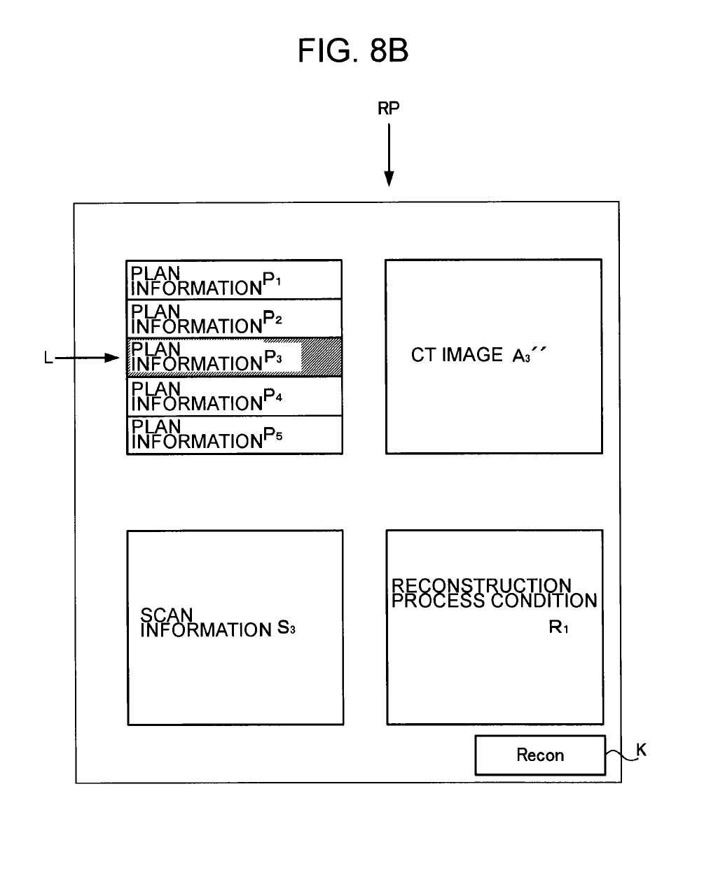

When the plan information P₃, which is different from the plan information P₁, is selected from the list L, the display controller 44 causes the display 46 to display both a CT image A₃ based on the X-ray scanning in accordance with the expert plan EP₃ corresponding to the plan information P₃ and the succeeded reconstruction process condition R₁ (see FIG. 8A).

The reconstruction processor 42b then implements again the reconstruction processing on the projection data configuring the CT image A₃ based on the reconstruction process condition R_{I}, and creates new CT image data. The display controller 44 causes the display 46 to display a CT image A₃″ based on the new CT image data (see FIG. 8B). The CT image A₃″ is an example of a “third CT image”

### Modified Example 2

In the second embodiment, the example in which the display controller 44 causes the display 46 to display, instead of the CT image A₃, the CT image A₃′ based on new CT image data was described. It is, on the other hand, also possible that the display controller 44 causes these CT images to be displayed on one screen.

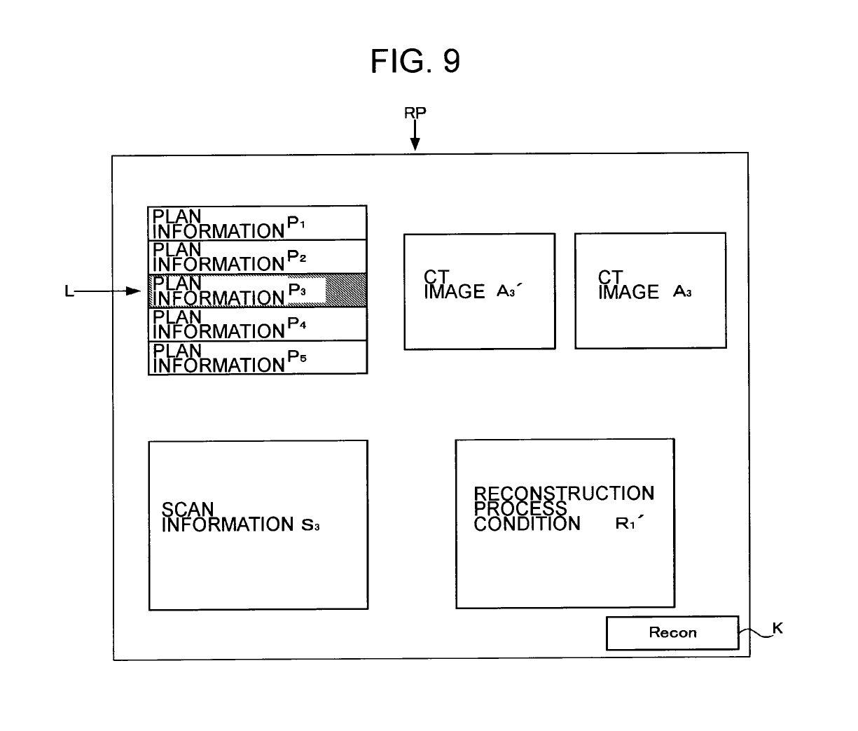

For example, the display controller 44 causes the display 46 to display the CT image A₃ (the second CT image) based on the reconstruction process condition R₃ and the CT image A₃′ (the third CT image) based on the reconstruction process condition R₁′ in parallel (see FIG. 9). It is also possible for the display controller 44 to cause the display 46 to display the CT image A₁ (the first CT image) based on the reconstruction process condition R₁ and the CT image A₁′ based on the reconstruction process condition R₁′ in parallel.

In this way, it is possible to decide ideal reconstruction process condition, and the like, for projection data by causing the display 46 to display a plurality of CT images obtained by applying different reconstruction process condition to the same projection data in parallel.

### Modified Example 3

In the second embodiment, the X-ray CT apparatus 1 may have an automatic succession mode (a first mode) and a manual succession mode (a second mode), as the succession operation modes for the changed reconstruction process condition. Here, the automatic succession mode is a mode such that it is determined whether succession of the changed reconstruction process condition based on a predetermined succession condition can be executed, and when it is determined that it is possible to succeed, the changed reconstruction process condition is succeeded to other plan information. On the contrary, the manual succession mode is a mode such that the changed reconstruction process condition is succeeded to other plan information, based on the instruction input via the input unit 47, or the like, for example. It is therefore possible for the X-ray CT apparatus 1 to succeed the changed reconstruction process condition to other plan information in accordance with the set succession operation mode.

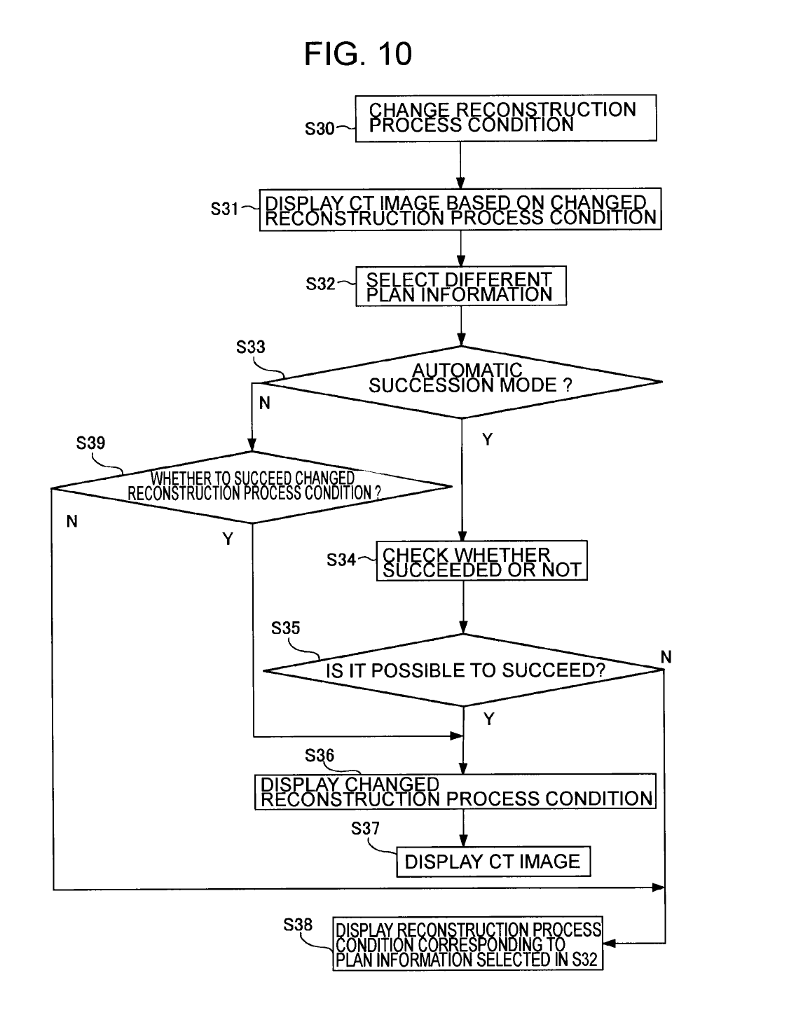

With reference to FIG. 10, operations of the X-ray CT apparatus 1 according to a third modified example are described. Here, it is described assuming that it is a state such that, similar to the state in FIG. 7, the plan information P₁ is selected from the list L and the scan information S₁, the CT image A₁, as well as the reconstruction process condition R₁ are displayed in the raw data page RP (the state in FIG. 3B of the first embodiment). Numbers S shown below are step numbers in FIG. 10.

For example, when a CT image easier to observe than the CT image A₁ currently displayed is required to obtain, the operator changes the value of the reconstruction process condition R₁ by the instruction input via the input unit 47. The changing unit 49 changes the reconstruction process condition R₁ based on the instruction input from the input unit 47 to generate a reconstruction process condition R₁′ (S30).

When the softkey K is selected in the state of S30, the reconstruction processor 42b again implements the reconstruction processing on the projection data configuring the CT image A₁ based on the reconstruction process condition R₁′, and creates CT image data. The display controller 44 causes the display 46 to display a CT image A₁′ based on the CT image data (S31).

It is then assumed that the plan information P₃, which is different form the plan information P₁, is selected in the raw data page RP by the operator (S32). At this point, the display controller 44 causes a CT image A₃ to be displayed in the raw data page RP.

Here, it is assumed that the above-mentioned succession operation mode is set in advance to the X-ray CT apparatus 1 (the controller 48) prior to S33. In the case that the automatic secession operation mode is set in advance (in the case that Y in S33), the controller 48 or the display controller 44 checks whether it is possible to succeed the reconstruction process condition R₁′ generated in S30 to the plan information selected in S32 (S34). In S34, the changed reconstruction process condition is checked whether it is possible to be succeeded to the plan information, which is a subject of the succession, selected in S32, based on at least one from, for example, the expert plan name, the plan information (the plan information selected in S32), the parameter at the time of scanning, and the parameter at the time of reconstruction processing.

As the result of the checking in S34, when it is determined that the succession is possible (in the case that Y in S35), the display controller 44 causes the display 46 to display the reconstruction process condition R₁′ generated in S30 (S36).

Further, when the softkey K is selected, the reconstruction processor 42b again implements the reconstruction processing on the projection data configuring the CT image A₃ in accordance with the reconstruction process condition R₁′, and creates new CT image data. The display controller 44 causes the display 46 to display, instead of the CT image A₃, a CT image A₃′ based on the new CT image data (S37).

On the other hand, as the result of the checking in S34, when it is determined that the succession is not possible (in the case that N in S35), the display controller 44 causes the display 46 to display the reconstruction process condition R₃ included in the expert plan EP₃ corresponding to the plan information P₃ selected in S32 (S38).

Further, in the case that the manual secession operation mode is set in advance in S33 (in the case that N in S33), it is determined whether to succeed the reconstruction process condition R₁′ generated in S30, based on the instruction input from the input unit 47. In the case that, based on the instruction input from the input unit 47, the reconstruction process condition R₁′ generated in S 30 is succeeded (in the case that Y in S39), the display controller 44 causes the display 46 to display the reconstruction process condition R₁′ (S36).

On the contrary, in the case that, based on the instruction input from the input unit 47, the reconstruction process condition R₁′ generated in S30 is not succeeded (in the case that N in S39), the display controller 44 causes the display 46 to display the reconstruction process condition R₃ included in the expert plan EP₃ corresponding to the plan information P₃ (S38).

In this way, it becomes possible to either succeed or not succeed to other plan information in accordance with the changed reconstruction process condition, and improve operability accompanying with the change in the reconstruction process condition.

### COMMON EFFECT OF THE EMBODIMENTS

According to the X-ray CT apparatus of at least one of the above-mentioned embodiments, by displaying the plan information indicating individual contents of a plurality of expert plans in a list, it is possible to instantaneously figure out the expert plan executed, and easily select a desired expert plan from a plurality of expert plans executed. It is also possible to appropriately combine the first embodiment with the second embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### EXPLANATION OF SYMBOLS

1 X-ray CT apparatus
10 Gantry apparatus
11 X-ray generator
12 X-ray detector
13 Rotating body
13a Aperture
14 High-voltage generator
15 Gantry driving unit
16 Collimator
17 Collimator driving unit
18 Data acquisition system
30 Couch apparatus
32 Couch driving unit
33 Couch top
34 Base
40 Console apparatus
41 Scan controller
42 Processor
42a Preprocessor
42b Reconstruction processor
42c Rendering processor
43 Creating unit
44 Display controller
45 Storage
46 Display
47 Input unit
48 Controller

1. An X-ray CT apparatus for X-ray scanning of a subject based on an operation plan including a scanning condition for the X-ray scanning, comprising:
a creating unit configured to create a list upon reception of plan information indicating individual contents of a plurality of operation plans executed to one subject, and; and
a display controller configured to cause a display to display the list created.

2. The X-ray CT apparatus according to claim 1, further comprising
a reconstruction processor configured to implement reconstruction processing on projection data corresponding to detection data obtained by the X-ray scanning based on a reconstruction process condition included in the operation plan, and to create CT image data, wherein
the display controller is configured, when desired first plan information is selected from the list, to cause the display to display a first CT image based on the X-ray scanning in accordance with a first operation plan corresponding to the first plan information as well as a first reconstruction process condition included in the first operation plan used for creating the first CT image.

3. The X-ray CT apparatus according to claim 2, further comprising
a changing unit configured to change the first reconstruction process condition displayed on the display, wherein
the display controller is configured, when second plan information different from the first plan information is selected from the list, to cause the display to display a second CT image based on the X-ray scanning in accordance with a second operation plan corresponding to the second plan information as well as the changed first reconstruction process condition.

4. The X-ray CT apparatus according to claim 2, wherein
the display controller is configured, when second plan information different from the first plan information is selected from the list, to cause the display to display a second CT image based on the X-ray scanning in accordance with a second operation plan corresponding to the second plan information as well as the first reconstruction process condition.

5. The X-ray CT apparatus according to claim 3, wherein
when the second plan information is selected from the list, the reconstruction processor is configured to create new CT image data by implementing the reconstruction processing again on the projection data configuring the second CT image based on the changed first reconstruction process condition, and
the display controller is configured to cause the display to display a third CT image based on the new CT image data.

6. The X-ray CT apparatus according to claim 4, wherein
when the second plan information is selected from the list, the reconstruction processor is configured to create new CT image data by implementing the reconstruction processing again on the projection data configuring the second CT image based on the first reconstruction process condition, and
the display controller is configured to cause the display to display a third CT image based on the new CT image.

7. The X-ray CT apparatus according to claim 5, wherein
the display controller is configured to cause the display to display the second CT image and the third CT image in parallel.

8. A display apparatus comprising:
a creating unit configured to create a list upon reception of plan information, which is executed on one subject and indicates individual contents of a plurality of operation plans including scanning conditions for X-ray scanning of the subject;
a display; and
a display controller configured to cause the display to display the list created.

9. The X-ray CT apparatus according to claim 6, wherein
the display controller is configured to cause the display to display the second CT image and the third CT image in parallel.
